(19) United States
(12) Patent Application Publication
(10) Pub. No.: US 2026/0143301 A1
(43) Pub. Date: May 21, 2026

(54) DATA PROPAGATION SYSTEM TRANSMITTING LATENCY-TOLERANT DATA ACROSS A VEHICLE POPULATION

(71) Applicant: GM Global Technology Operations LLC, Detroit, MI (US)

(72) Inventors: Spencer Taft, Victoria (CA); Alaa M. Khamis, Courtice (CA); Antonino Candela, Royal Oak, MI (US); Mohammad Naserian, Windsor (CA)

(21) Appl. No.: 18/952,198

(22) Filed: Nov. 19, 2024

(51) Int. Cl. H04W 4/021; H04W 4/44; H04W 24/08; H04W 48/18

(52) U.S. Cl. CPC H04W 4/022; H04W 4/44; H04W 24/08; H04W 48/18

(57) ABSTRACT

A data propagation system includes one or more data mules that transmit latency-tolerant data across a vehicle population, where each data mule receives the latency-tolerant data from one or more back-office servers and the data mules maintain a polling connection with the back-office servers. In embodiments, the data propagation system includes one or more controllers that are part of an ego vehicle, wherein the ego vehicle is part of the vehicle population, where the one or more controllers include one or more processors that execute instructions to establish a wireless connection to a geofence network as the ego vehicle drives along a navigational route. In another embodiment, the data propagation system includes one or more back-office servers in wireless communication with the plurality of vehicles that are part of the vehicle population. The back-office servers identify one or more data mules based on a modified cumulative rank score.

### INTRODUCTION

The present disclosure relates to a data propagation system including one or more data mules that transmit latency-tolerant data across a vehicle population. Each data mule receives the latency-tolerant data from one or more back-office servers, where the data mule maintains a polling connection with the back-office servers.

A software-defined vehicle is any vehicle that manages operations, adds functionality, and enables new features either primarily or entirely through software updates. It is to be appreciated that software-defined vehicles require software configuration updates from back-office servers at periodic time intervals. For example, vehicles originating from a common original equipment manufacturer (OEM) may each poll the back-office servers every five minutes for software configuration updates or other types of latency-tolerant data such as, but not limited to, weather data and telemetry from software applications.

Although the amount of data transmitted between a particular vehicle and the back-office servers is relatively small (typically less than about one kilobyte of data per minute), the resources required for opening and maintaining a back-end connection between the particular vehicle and the back-office servers may be relatively high. Furthermore, maintaining numerous connections between the back-office servers and the vehicles that originate from the common OEM also requires increased resources as well. Moreover, it is also to be appreciated that sometimes vehicles may be located in remote or rural areas with limited network connectivity, which may adversely affect a vehicle's connection with the back-office servers.

Thus, while current approaches to perform software configuration updates achieve their intended purpose, there is a need in the art for an approach that performs software configuration updates while minimizing the number of active connections between the back-office servers and a vehicle population.

### SUMMARY

According to several aspects, a data propagation system including one or more data mules transmitting latency-tolerant data across a vehicle population that includes a plurality of vehicles is disclosed. The data propagation system includes one or more controllers that are part of an ego vehicle, where the ego vehicle is part of the vehicle population. The one or more controllers include one or more processors that execute instructions to establish a wireless connection to a geofence network as the ego vehicle drives along a navigational route. The geofence network represents a virtual polygon that bounds a specific geographical area and includes one or more stationary communication nodes and one or more moveable communication nodes that define the virtual polygon. The one or more data mules are part of the geofence network and are located within the virtual polygon that bounds the specific geographical area of the geofence network. In response to connecting with the geofence network, the one or more controllers select a particular data mule located within the specific geographical area of the geofence network to receive the data, where the particular data mule maintains a polling connection to receive the latency-tolerant data from one or more back-office servers. The one or more controllers monitor the wireless connection between the ego vehicle and the geofence network to determine the ego vehicle has driven outside of the specific geographical area bounded by the geofence network. Finally, in response to determining the ego vehicle has driven outside of the specific geographical area bounded by the geofence network, the one or more controllers disconnect the wireless connection to the geofence network.

In another aspect, the size of the virtual polygon that bounds the specific geographical area of the geofence network is dynamically expanded by introducing one or more additional communication nodes to the geofence network.

In yet another aspect, the virtual polygon of the geofence network is dynamically expanded based on a pointer network-based convex hull.

In an aspect, the one or more stationary communication nodes are represented by one or more of the following: buildings, infrastructure, vehicle dealerships, original equipment manufacturer (OEM) infrastructure, and infrastructure that the OEM has an agreement with.

In another aspect, the one or more moveable communication nodes are represented by one or more of the following: one of the plurality of vehicles that are part of the vehicle population, the ego vehicle, and the one or more data mules.

In yet another aspect, the ego vehicle is a software-defined vehicle.

In an aspect, the latency-tolerant data includes at least one of the following: software configuration data, weather data, vehicle configuration data, news, local events, traffic updates, map data updates, software application updates, and vehicle software updates.

In yet another aspect, two or more data mules are located within the geofence network, and where the one or more controllers of the ego vehicle execute instructions to select the particular data mule based on one or more selection criteria.

In an aspect, the one or more selection criteria include one or more of the following: a distance between the particular data mule to the ego vehicle, a freshness of the latency-tolerant data received by the particular data mule from the one or more back-office servers, and one or more user-based preferences.

In another aspect, the one or more controllers wirelessly connect to the one or more data mules by a heterogenous mesh network.

In another aspect, a method for identifying one or more vehicles that are part of a vehicle population as a data mule that transmits latency-tolerant data across a vehicle population is disclosed. The method includes dividing, by one or more back-office servers, a target region into two or more subregions, where a plurality of vehicles that are part of the target region are located within the target region and the one or more back-office servers are in wireless communication with the plurality of vehicles. The method includes constructing, by the one or more back-office servers, an undirected graph for each of the two or more subregions of the target region, where each undirected graph includes a plurality of nodes that each represent one of the plurality of vehicles of the vehicle population and a plurality of edges that each represent a wireless connection between two of the plurality of vehicles. The method also includes calculating a modified cumulative rank score for each node included within the target region. The method includes identifying one or more vehicles from each of the two or more subregions that are part of the target region as the data mule based on the modified cumulative rank score corresponding to each of the plurality of vehicles that are part of the vehicle population. The method includes transmitting, by the one or more back-office servers, a most recent version of the latency-tolerant data to the one or more data mules, where the one or more data mules maintain a polling connection to receive the latency-tolerant data from one or more back-office servers. Finally, the method includes transmitting, by the one or more the data mules, the latency-tolerant data to the plurality of vehicle that are part of the vehicle population.

In another aspect, a data propagation system that includes one or more data mules transmitting latency-tolerant data across a vehicle population including a plurality of vehicles located within a target region is disclosed. The data propagation system includes one or more back-office servers in wireless communication with the plurality of vehicles that are part of the vehicle population. The one or more back-office servers include one or more processors that execute instructions to divide a target region into two or more subregions, wherein a plurality of vehicles that are part of the target region are located within the target region and the one or more back-office servers are in wireless communication with the plurality of vehicles. The one or more back-office servers construct an undirected graph for each of the two or more subregions of the target region, where each undirected graph includes a plurality of nodes that each represent one of the plurality of vehicles of the vehicle population and a plurality of edges that each represent a wireless connection between two of the plurality of vehicles. The one or more back-office servers calculate a modified cumulative rank score for each node included within the target region. The one or more back-office servers identify one or more vehicles from each of the two or more subregions that are part of the target region as the data mule based on the modified cumulative rank score corresponding to each of the plurality of vehicles that are part of the vehicle population. The one or more back-office servers transmit a most recent version of the latency-tolerant data to the data mules, where the data mules maintain a polling connection to receive the latency-tolerant data from one or more back-office servers and transmit the latency-tolerant data to the plurality of vehicles that are part of the vehicle population.

In yet another aspect, the modified cumulative rank score is determined based on a local performance score and a global performance score.

In an aspect, the local performance score is represented by an improved network connectivity coefficient that is a measure of first-degree connections and second-degree connections of a particular vehicle over a specific timespan assigned to a subregion the particular vehicle is located within.

In another aspect, the specific timespan is determined based on the frequency of interactions between the plurality of vehicles located within a particular subregion.

In yet another aspect, the global performance score is represented by a tenacity of a particular vehicle, and the tenacity is a measure of the importance of a particular vehicle in maintaining the wireless connections between the plurality of vehicles of the vehicle population.

In an aspect, the local performance score is determined as:

$$modified cumulative rank score = ( local performance score * α ) + ( global performance score * β )$$

where α represents a local performance weight and β represents a global performance weight.

In another aspect, the plurality of vehicles include at least one software-defined vehicle.

In yet another aspect, the latency-tolerant data includes at least one of the following: software configuration data, weather data, vehicle configuration data, news, local events, traffic updates, map data updates, software application updates, and vehicle software updates.

In an aspect, one or more controllers of each data mule execute a startup subscribe logic that identifies a particular vehicle that is part of the vehicle population as a potential data mule.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 illustrates a schematic diagram of the disclosed data propagation system including one or more data mules in wireless communication with one or more back-office servers, where the one or more data mules transmit latency-tolerant data received from the back-office servers to a vehicle population, according to an exemplary embodiment;

FIG. 2 illustrates a process flow diagram of a method for determining if a particular vehicle that is part of the vehicle population is identified as a data mule, according to an exemplary embodiment;

FIG. 3 is an illustration of an exemplary geofence network, according to an exemplary embodiment;

FIG. 4 illustrates a process flow diagram of a method for transmitting the latency-tolerant data from the data mule to the ego vehicle based on the geofencing network shown in FIG. 3, according to an exemplary embodiment;

FIG. 5 is an illustration of a heterogenous mesh network for connecting an ego vehicle with a data mule, according to an exemplary embodiment;

FIG. 6 is an illustration of an exemplary target region that has been divided into two or more subregions, according to an exemplary embodiment;

FIG. 7 is a process flow diagram illustrating a method for identifying one or more vehicles of the vehicle population as a data mule, according to an exemplary embodiment; and

FIG. 8 is a process flow diagram illustrating a method of transmitting the latency-tolerant data from the data mule to a vehicle based on a spontaneous spreading approach, according to an exemplary embodiment.

### DETAILED DESCRIPTION

The following description is merely exemplary in nature and is not intended to limit the present disclosure, application, or uses.

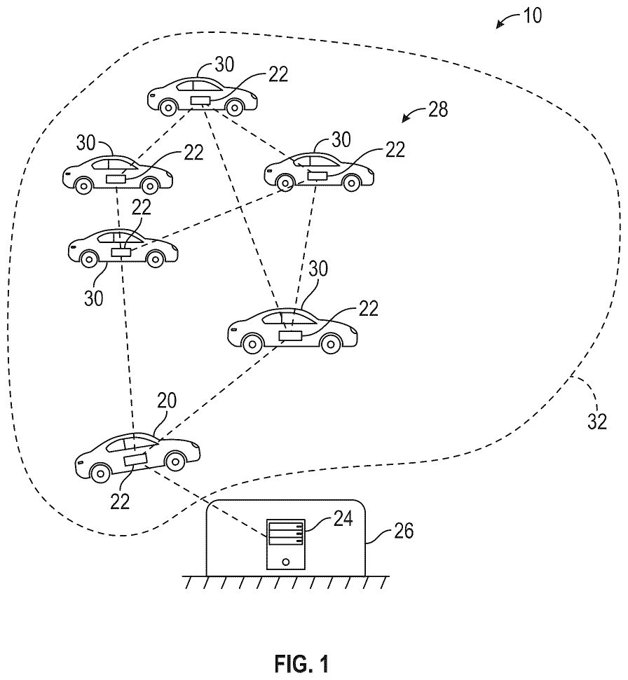

Referring to FIG. 1, a schematic diagram of the disclosed data propagation system 10 is illustrated. The data propagation system 10 includes one or more data mules 20 that each include one or more controllers 22. The one or more controllers 22 of the data mule 20 are in wireless communication with one or more back-office servers 24 located at a back-office 26. It is to be appreciated that the data mule 20 is a vehicle such as, but not limited to, a sedan, truck, sport utility vehicle, van, or motor home. The data mule 20 is part of a vehicle population 28 that includes a plurality of vehicles 30 that are located within a target region 32. The target region 32 may represent any geographical region such as, but not limited to, a country such as the United States or Canada, a state such as Michigan or Ohio, a city, or a rural district. In one embodiment, the data mule 20 and the plurality of vehicles 30 are software-defined vehicles, however, it is to be appreciated that the vehicle population 28 may include non-software-defined vehicles as well.

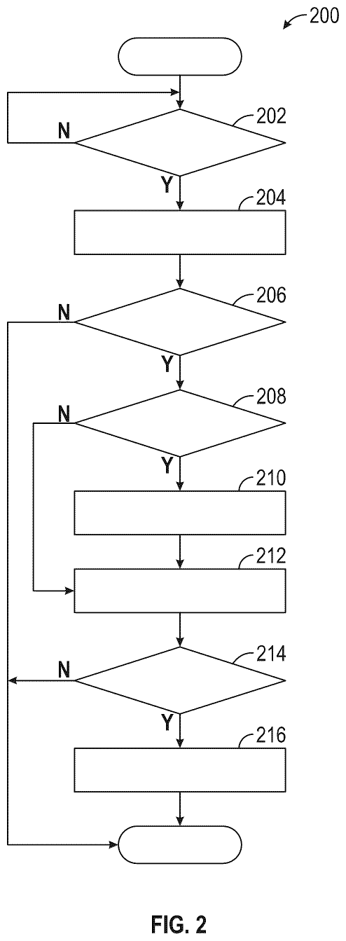

The one or more controllers 22 of the data mule 20 maintain a polling connection to receive latency-tolerant data from the one or more back-office servers 24. The polling connection requires the one or more controllers 22 of the data mule 20 to poll the back-office servers 24 at a periodic time interval. In one non-limiting embodiment, the periodic time interval is five minutes, however, it is to be appreciated that other time intervals that are less than or greater than five minutes may be used as well. In one exemplary embodiment, the latency-tolerant data received from the one or more back-office servers 24 includes software configuration updates for software-defined vehicles. In addition to or in the alternative, the one or more controllers 22 of the data mule 20 may also receive other types of latency-tolerant data such as, for example, weather data, vehicle configuration data, news, local events, traffic updates, map data updates, software application updates, and vehicle software updates. The one or more data mules 20 pollinate or transmit the latency-tolerant data received from the one or more back-office servers 24 to the one or more vehicles 30 that are part of the vehicle population 28 while traveling along a navigational route. Specifically, the one or more controllers 22 of a vehicle 30 may be identified as a data mule 20 by executing a startup subscribe logic, which is explained below and illustrated in FIG. 2. As seen in FIG. 1, the one or more vehicles 30 of the vehicle population 28 are in wireless communication with one another based on a wireless networking protocol such as, but not limited to, a vehicle-to-vehicle (V2V) communication network.

Upon startup of a particular vehicle 30 located in the target region 32, the startup subscribe logic of the one or more controllers 22 of the particular vehicle 30 first checks to ensure that a user associated with the particular vehicle 30 has consented to having the particular vehicle 30 become a data mule. In response to confirming that the user associated with the particular vehicle 30 has consented to being a data mule, the one or more controllers 22 then confirms the particular vehicle 30 is healthy enough to become a data mule. In response to determining the particular vehicle 30 is healthy enough to become a data mule, the one or more controllers 22 then checks to confirm that a navigational route selected by the user associated with the particular vehicle 30 allows for the particular vehicle 30 to become a super spreader of the latency-tolerant data received from the one or more back-office servers 24.

FIG. 2 is an exemplary process flow diagram illustrating a method 200 of executing the startup subscribe logic by the one or more controllers 22 of a particular vehicle 30 that is part of the vehicle population 28, where the startup subscribe logic that identifies a particular vehicle 30 that is part of the vehicle population 28 as a potential data mule. Referring to both FIGS. 1 and 2, the method 200 begins at decision block 202. In decision block 202, the one or more controllers 22 confirm that the particular vehicle 30 has started up, and that the user associated with the particular vehicle 30 has consented to having the particular vehicle 30 become a data mule. In embodiments, the user may receive a monetary reward or other incentive for consenting to become a data mule. In response to determining the vehicle 30 is started and confirming that the user associated with the particular vehicle 30 has consented to the particular vehicle 30 becoming a data mule, the method 200 may then proceed to block 204. Otherwise, the method 200 terminates.

In block 204, the one or more controllers 22 determine the health of the particular vehicle 30. The health of the particular vehicle 30 may include factors such as, but not limited to, battery charge remaining, a network status, and the presence of specialized configuration software executed by the one or more controllers 22. The specialized configuration software may be, for example, a user-specific configuration or a vehicle-specific configuration to mitigate a pre-existing software issue. It is to be appreciated that the specialized configuration software is not to be overridden. The method 200 may then proceed to decision block 206.

In decision block 206, the one or more controllers 22 compare the health of the particular vehicle 30 with a predefined level of vehicle health associated with a data mule. The predefined level of vehicle health may include specific thresholds for various vehicle health indicators such as the battery charge remaining, the strength or presence of the network status, and the absence of the specialized configuration software executed by the one or more controllers 22, where the specific thresholds are selected to ensure that the particular vehicle 30 may function as a data mule to transmit the latency-tolerant data received from the one or more back-office servers 24. In response to determining the health of the particular vehicle 30 is equal to or greater than the predefined level of vehicle health associated with a data mule, the method 200 proceeds to decision block 208. Otherwise, the method 200 may terminate.

In decision block 208, the one or more controllers 22 determine the amount of time that has elapsed since the particular vehicle 30 downloaded the latency-tolerant data from the one or more back-office servers 24. The one or more controllers 22 compare the amount of time that has elapsed since the particular vehicle 30 downloaded the latency-tolerant data from the one or more back-office servers 24 with a threshold refresh amount of time, where the threshold refresh amount time is selected to ensure that the particular vehicle 30 includes the most up-to-date software configuration data (or other latency-tolerant data, if applicable). In response to determining the amount of time that has elapsed since the particular vehicle 30 downloaded the latency-tolerant data from the one or more back-office servers 24 is greater than the threshold refresh amount of time, the method 200 proceeds to block 210. Otherwise, the method 200 proceeds to block 212.

In block 210, the one or more controllers 22 download the latest version of the latency-tolerant data from the one or more back-office servers 24. The method 200 may then proceed to block 212.

In block 212, the one or more controllers 22 receive a navigational route selected by the user associated with the particular vehicle 30. The method 200 may then proceed to decision block 214.

In decision block 214, the one or more controllers 22 analyze the navigational route selected by the user associated with the particular vehicle 30 to determine if the particular vehicle 30 is a super spreader of data. Some factors that determine if a vehicle 30 is a super spreader of data include, but are not limited to, a number of vehicles encountered, the density of vehicles on the navigational route, and cumulative rank to the vehicle population.

In response to determining the navigational route selected by the user allows for the particular vehicle 30 to become a super spreader of the latency-tolerant data received from the one or more back-office servers 24, the method 200 may then proceed to block 216. Otherwise, the method 200 may terminate.

In block 216, the one or more controllers 22 identify the particular vehicle 30 as the data mule 20. In embodiments, the one or more controllers 22 download the latest version of the latency-tolerant data from the one or more back-office servers 24. The method 200 may then terminate.

Referring back to FIG. 1, once the data mule 20 is identified, the data mule 20 may then transmit the latency-tolerant data received from the one or more back-office servers 24 to one or more vehicles 30 that are part of the vehicle population 28 based on a geofencing approach, a spatial clustering approach, or a spontaneous spreading approach, which are each described below.

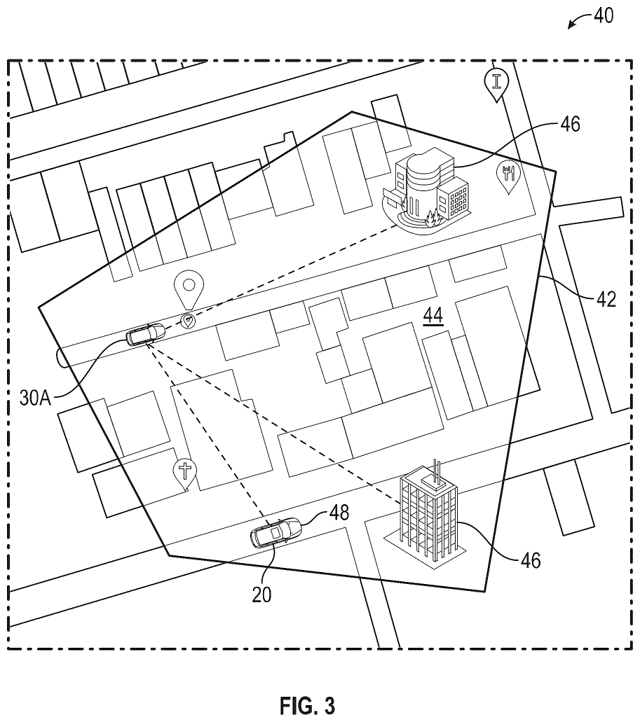

The geofencing approach shall now be described. FIG. 3 is an illustration of an exemplary geofence network 40 that represents a virtual perimeter or polygon 42 that bounds a specific geographical area 44. The geofence network 40 includes one or more stationary communication nodes 46 and one or more moveable communication nodes 48 that both define the virtual polygon 42 that bounds the specific geographical area 44. The one or more stationary communication nodes 46 are in wireless communication with one of the vehicles 30A of the vehicle population 28 based on a wireless networking protocol, where the vehicle 30A is referred to as the ego vehicle 30A. In the non-limiting embodiment as shown in FIG. 3, the one or more stationary communication nodes 46 are represented by buildings that have wireless communication capabilities for wirelessly connecting with the ego vehicle 30A. However, it is to be appreciated that the one or more stationary communication nodes 46 may be represented any other types of stationary object having wireless capabilities as well such as, for example, infrastructure such as smart traffic lights and smart road signs, vehicle dealerships, original equipment manufacturer (OEM) infrastructure, and infrastructure that the OEM has an agreement with. Some examples of the wireless networking protocol for connecting the ego vehicle 30A with the one or more stationary nodes 46 include, but are not limited to, a vehicle-to-everything (V2X) communication network.

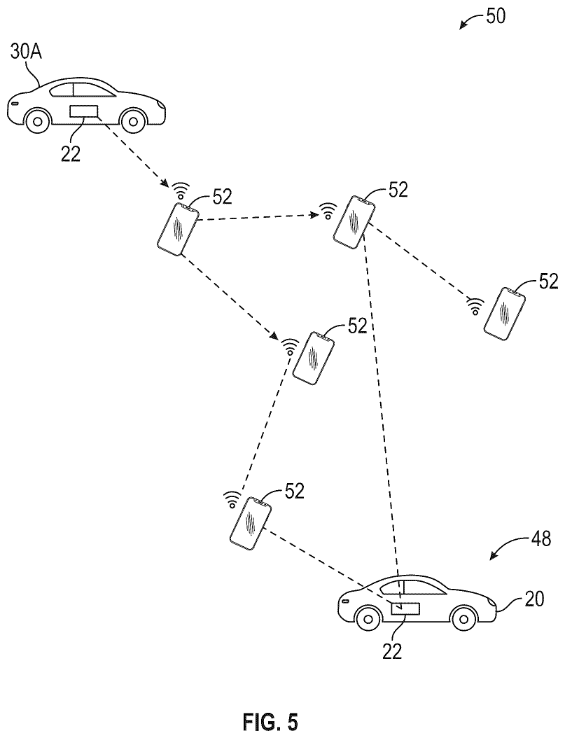

The one or more moveable communication nodes 48 are in wireless communication with the ego vehicle 30A based on the wireless networking protocol. The one or more moveable communication nodes 48 include objects without a fixed location such as one of the vehicles 30 that are part of the vehicle population 28, the one or more data mules 20, or mesh enabled devices 52 (shown in FIG. 5) such as smartphones, tablet computers, or laptop computers. In one embodiment, the geofence network 40 is an elastic geofence network, where the size of the virtual polygon 42 that bounds the specific geographical area 44 is dynamically expanded by introducing one or more additional communication nodes 46, 48 to the geofence network 40. In one embodiment, the virtual polygon 42 of the geofence network 40 is dynamically expanded based on a pointer network-based convex hull. Specifically, a pointer network-based convex hull identifies one or more moveable communication nodes 48 located within the geofence network 40 that do not expand the virtual polygon 42, where the moveable communication nodes 48 that do not expand the virtual polygon 42 are removed from the geofence network 40. Similarly, the pointer network-based convex hull identifies one or more moveable communication nodes 48 located within the geofence network 40 that expand the virtual polygon 42, where the moveable communication nodes 48 that expand the virtual polygon 42 are introduced to the geofence network 40.

As seen in FIG. 3, one or more data mules 20 are located within the virtual polygon 42 that bounds the specific geographical area 44 of the geofence network 40. The ego vehicle 30A is in wireless communication with the one or more data mules 20 based on the wireless networking protocol. As explained below, in one embodiment, a heterogenous mesh network 50 (shown in FIG. 5) wirelessly connects the ego vehicle 30A with the one or more data mules 20. In one embodiment, one or more spatial clustering algorithms such as, for example, a k-means or an x-means clustering algorithm may be executed to create vehicle clusters within the geofenced network 40, where one or more data mules 20 are located at the center of the vehicle cluster. The vehicles 30 of the vehicle population 28 may be directed towards the center of the vehicle cluster to receive the latency-tolerant data from one of the data mules 20.

In the event the ego vehicle 30A connects to more than one data mule 20 that is located within the specific geographical area 44 of the geofence network 40, the one or more controllers 22 of the ego vehicle 30A select a particular data mule 20 located within located within the specific geographical area 44 of the geofence network 40 to receive the latency-tolerant data from based on one or more selection criteria. In one embodiment, the one or more selection criteria include a distance between the particular data mule 20 to the ego vehicle 30A, a freshness of the latency-tolerant data received by the particular data mule 20 from the one or more back-office servers 24, and one or more user-based preferences. Specifically, the one or more user-based preferences include, but are not limited to, a preference to always connect to static infrastructure if available, to connect to same make/model if available, and connect to vehicles travelling same direction if available.

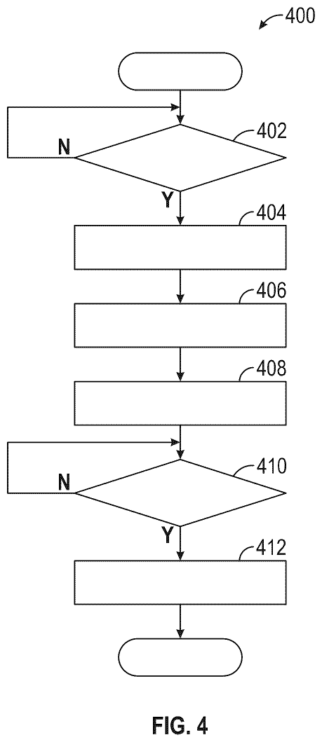

FIG. 4 is a process flow diagram illustrating a method 400 for transmitting the latency-tolerant data from the data mule 20 to the ego vehicle 30A based on the geofencing approach. Referring to both FIGS. 1 and 4, the method 400 may begin at decision block 402. In decision block 402, the ego vehicle 30A continues to drive along a navigational route until entering the geofence network 40. It is to be appreciated that in embodiment, the navigational route of the ego vehicle 30A may be altered to reduce the amount of time before the ego vehicle 30A enters a particular geofence network 40 while driving. In particular, the navigational route of the ego vehicle 30A may be altered in response to determining a new version of the latency-tolerant data, such as a software configuration updates for a software-defined vehicle, is available. In response to entering the specific geographical area 44 of the geofence network 40, the method 400 may proceed to block 404.

In block 404, the one or more controllers 22 of the ego vehicle 30A establishes a wireless connection to the geofence network 40 as the ego vehicle 30A drives along the navigational route. The method 400 may then proceed to block 406.

In block 406, in response to connecting with the geofence network 40, the one or more controllers 22 of the ego vehicle 30A selects a particular data mule 20 located within the specific geographical area 44 of the geofence network 40 to receive the latency-tolerant data from. As mentioned above, in the event there are two or more data mules 20 located within the geofence network 40, then the one or more controllers 22 selects a particular data mule 20 based on the one or more selection criteria as described above. The method 400 may then proceed to block 408.

In block 408, in one embodiment, the size of the virtual polygon 42 that bounds the specific geographical area 44 of the geofence network 40 is dynamically expanded by introducing the one or more controllers 22 of the ego vehicle 30A to the geofence network 40. It is to be appreciated that block 408 is optional and may be omitted in some embodiments. The method 400 may then proceed to decision block 410.

In decision block 410, the one or more controllers 22 of the ego vehicle 30A continue to monitor the wireless connection between the ego vehicle 30A and the geofence network 40 until determining the ego vehicle 30A has driven outside of the specific geographical area 44 bounded by the geofence network 40. In response to determining the ego vehicle 30A has driven outside of the specific geographical area 44 bounded by the geofence network 40, the method 400 may proceed to block 412.

In block 412, in response to determining the ego vehicle 30A has driven outside of the specific geographical area 44 bounded by the geofence network 40, the one or more controllers 22 of the ego vehicle 30A disconnects the wireless connection to the geofence network. The method 400 may then terminate.

FIG. 5 is an illustration of the heterogenous mesh network 50 for connecting the ego vehicle 30A with the one or more data mules 20. The heterogenous mesh network 50 includes a plurality of mesh enabled devices 52 that wirelessly connect the one or more controllers 22 of the ego vehicle 30A with the one or more data mules 20. In the embodiment as shown in FIG. 5, the mesh enabled devices 52 are smartphones. However, it is to be appreciated that the mesh enabled devices 52 may be any type of device that includes short-range wireless capabilities such as, but not limited to, a controller of a vehicle 30, a tablet computer, a laptop computer, and a smartphone. Specifically, it is to be appreciated that the mesh enabled devices 52 follow one or more short-range wireless communication protocols such as, for example, an ultra-wide band network (UWB network), a low-power mesh networking protocol based on the Institute of Electrical and Electronics Engineers (IEEE) 802.15 family of standards (i.e., BLUETOOTH® Low Energy (BLE)), or a short-range network based on the IEEE 802.11 family of standards (i.e., Wi-Fi®). In the event one or more of the mesh enabled devices 52 do not include short-range wireless communication capabilities, the heterogenous mesh network 50 may include a proxy node that allows for wireless communication between the heterogenous mesh network 50 and the particular mesh enabled devices 52.

The one or more controllers 22 of the ego vehicle 30A may transmit a request to connect with and receive the latency-tolerant data from one of the data mules 20. In the event no other vehicles 30 that are part of the vehicle population 28 are within the vicinity of the ego vehicle 30A to receive the request, then the request is received by one or more of the mesh enabled device 52 of the heterogenous mesh network 50. It is to be appreciated that the specific mesh enabled device 52 is located within the transmission range specified by the short-range wireless communication protocol. The specific mesh enabled device 52 may then relay the request received from the ego vehicle 30A one or more remaining mesh enabled devices 52 that are part of the heterogenous mesh network 50 based on ad-hoc communication. The remaining mesh enabled devices 52 may then continue to re-transmit the request between one another until the request is received by one of the data mules 20. In one embodiment, instead of re-transmitting the request between the remaining mesh enabled devices 52, if a particular mesh enabled device 52 includes cellular network connectivity (i.e., the mesh enabled device 52 includes ONSTAR® connectivity) or is a gateway node (i.e., a Wi-Fi® gateway), then the ego vehicle 30A may extract the latency-tolerant data from the particular mesh enabled device 52.

The spatial clustering approach shall now be described. As seen in FIG. 1, the one or more vehicles 30 of the vehicle population 28 are in wireless communication with one another based on a wireless networking protocol such as a V2V communication network. As explained below, the spatial clustering approach involves first identifying one or more vehicles 30 of the vehicle population 28 as a data mule 20. Specifically, the data mule 20 is identified based on a vehicle's ability to spread the latency-tolerant data across the vehicle population. That is, in other words, one of the vehicles 30 of the vehicle population 28 are selected based on the ability to be a super-spreader of the data.

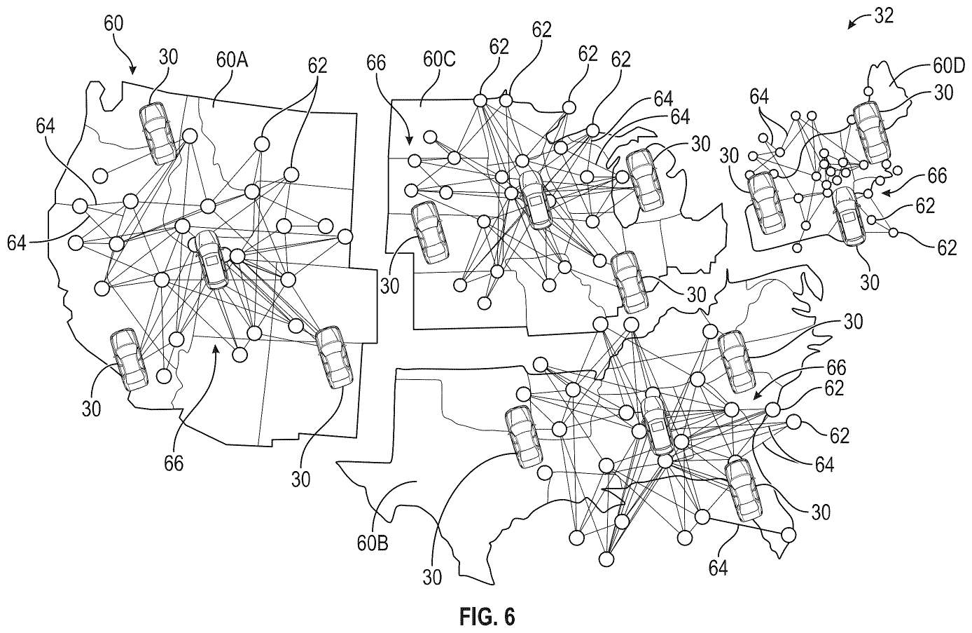

It is to be appreciated that the one or more back-office servers 24 located at the back-office 26 are in wireless communication with the plurality of vehicles 30 that are part of vehicle population 28 and identify the vehicles 30 that are data mules 20. The one or more back-office servers 24 monitor the vehicle population 28 as the vehicles 30 travel and collect metadata. Some examples of the metadata include, but are not limited to, the density of traffic in typical routes, the typical route, and vehicle health. The one or more back-office servers 24 monitor the metadata collected by the plurality of vehicle 30 of the vehicle population 28 and continue to compare an amount of metadata collected by the plurality of vehicles 30 with a threshold amount of metadata. The threshold amount of metadata is selected so that when the metadata is divided into the two or more subregions 60, there is a sufficient amount of metadata to perform cumulative ranking to determine the super spreader. In response to determining the amount of metadata collected by the plurality of vehicles 30 is equal to or greater than the threshold amount of metadata, one or more back-office servers 24 may then divide the target region 32 into two or more subregions 60, which is shown in FIG. 6.

FIG. 6 is an illustration of an exemplary target region 32 that has been divided into two or more subregions 60. Specifically, in the non-limiting embodiment as shown in FIG. 6, the target region 32 is the United States and there are four subregions 60, which include a western subregion 60A, a southern subregion 60B, a midwestern subregion 60C, and a northeastern subregion 60D. However, as mentioned above, it is to be appreciated that the target region 32 is not limited to a specific region such as the United States. In one embodiment, the subregions 60 are determined by the total number of vehicles 30 located within each individual subregion, however, it is to be appreciated that the subregions 60 may be determined based on other factors as well such as, but not limited to, population density, geography, and network availability. It is to be appreciated that a disparate number of vehicles 30 may be included by each of the subregions 60. Merely by way of example, the southern subregion 60B may include about 130 million vehicles 30 while the northeastern subregion 60D may include 58 million vehicles 30.

Referring to both FIGS. 1 and 6, once the one or more back-office servers 24 divide the target region 32 into the two or more subregions 60, the one or more back-office servers 24 may then assign a specific timespan to each subregion 60, where the specific timespan is determined based on the frequency of interactions between the plurality of vehicles 30 located within a particular subregion 60 over a wireless network that connects the vehicles 30 to one another. It is to be appreciated that each subregion 60 of the target region 32 may be assigned a unique timespan since wireless interactions between the vehicles 30 change relatively frequently between different subregions 60. In one non-limiting embodiment, the specific timespan for a particular subregion 60 may be one week, however, it is to be appreciated that other timespans may be used as well.

The one or more back-office servers 24 may then construct an undirected graph 66 for each of the two or more subregions 60 of the target region 32, where each undirected graph 66 includes a plurality of nodes 62 that each represent one of the vehicles 30 that are part of the vehicle population 28 and a plurality of edges 64 that each represent a wireless connection between two of the vehicles 30. It is to be appreciated that the plurality of edges 64 of the undirected graph 66 are bidirectional.

The one or more back-office servers 24 may then calculate a modified cumulative rank score for each node 62 (i.e., each vehicle 30 that is part of the vehicle population 28) included within the target region 32. The one or more back-office servers 24 then identify one or more vehicles 30 of the vehicle population 28 as a data mule 20 based on the modified cumulative rank score corresponding to each vehicle 30 that is part of the vehicle population 28. It is to be appreciated that the modified cumulative rank score corresponding to each vehicle 30 is determined based on a local performance score and a global performance score, which are both explained below.

Calculating the modified cumulative rank score corresponding to each vehicle 30 that is part of the vehicle population 28 shall now be described. The one or more back-office servers 24 first determine the local performance score for each vehicle 30, where the local performance score is based on a degree centrality and a local rank of each vehicle 30. The local performance score is represented by an improved network connectivity coefficient INCC. The improved network connectivity coefficient INCC focuses on the local structure around a node 62 (i.e., a vehicle 30). Specifically, the improved network connectivity coefficient INCC represents a measure of first-degree connections and second-degree connections of a particular vehicle 30 over the specific timespan assigned to the subregion 60 that the particular vehicle 30 is located within. It is to be appreciated that the improved network connectivity coefficient INCC accounts not only for the number of first- and second-degree connections but also the quality and centrality of the first- and second-degree connections.

The one or more back-office servers 24 then determine the global performance score for each vehicle 30, where the global performance score is represented by a tenacity of a particular vehicle 30. The tenacity is a measure of the importance of a particular node 62 (i.e., a particular vehicle 30) in maintaining the wireless connections between the plurality of vehicles 30 of the vehicle population 28. In other words, the tenacity indicates the importance of a particular node 62 upon the network by measuring the impact the particular node 62 would have if removed. The tenacity of a particular vehicle 30 is based on the impact of a network breakage caused by the particular vehicle 30, a number of nodes that are part of a network that connects the particular vehicle 30 to the remaining vehicle population 28, and the size of the largest node that is part of the network. It is to be appreciated that the tenacity of the particular vehicle 30 is first normalized before being combined with the local performance score to determine the modified cumulative rank score.

Once the global performance score and the local performance score are determined, the one or more back-office servers 24 may then calculate the modified cumulative rank score for each vehicle 30 that is part of the vehicle population 28 included within the target region 32 by combining the global performance score with the local performance score together. Specifically, in one embodiment, the modified cumulative rank score is calculated for each vehicle 30 based on the following equation below:

modified cumulative rank score=(local performance score*α)+(global performance score*β)

where α represents a local performance weight and β represents a global performance weight. The local performance weight α and the global performance weight β are both adjustable values.

Once the modified cumulative rank score for each vehicle 30 is determined, the one or more back-office servers 24 then identify one or more vehicles 30 from each subregion 60 that is part of the target region 32 as one of the data mules 20 based on a corresponding modified cumulative rank score. Specifically, as the score of the modified cumulative rank score decreases, the higher the influence a particular vehicle 30 may have in facilitating the flow of information and maintaining network connectivity. Accordingly, in one embodiment, the one or more back-office servers 24 select an N number of vehicles 30 that are part of the vehicle population 28 having the lowest modified cumulative rank score to be the data mules 20, where the number N is equal to or greater than 1. Once the data mules 20 are identified, the one or more back-office servers 24 may then push or transmit the most recent version of the latency-tolerant data to the data mules 20. The data mules 20 may then transmit the latency-tolerant data to the vehicle population 28.

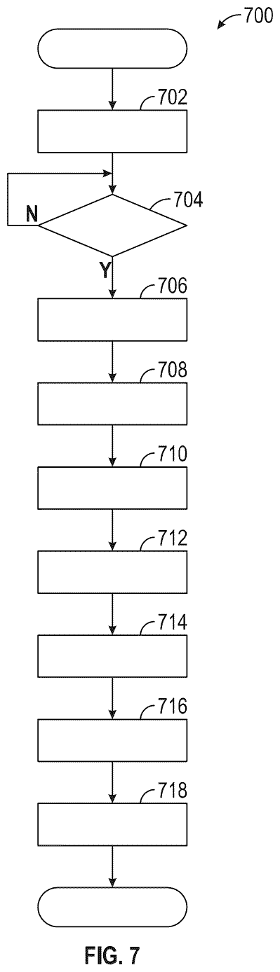

FIG. 7 is a process flow diagram illustrating a method 700 for identifying one or more vehicles 30 of the vehicle population 28 as a data mule 20. Referring to FIGS. 1, 6, and 7, the method 700 may begin at block 702. In block 702, the one or more back-office servers 24 monitor the metadata collected by the plurality of vehicle 30 that are part of the vehicle population 28. The method 700 may then proceed to block 704.

In block 704, the one or more back-office servers 24 continue to compare the amount of metadata collected by the plurality of vehicles 30 with a threshold amount of metadata until determining the amount of metadata collected by the plurality of vehicles 30 is equal to or greater than the threshold amount of metadata. In response to determining the amount of metadata collected by the plurality of vehicles 30 is equal to or greater than the threshold amount of metadata, the method 700 may then proceed to block 706.

In block 706, in response to determining the amount of metadata collected by the plurality of vehicles 30 is equal to or greater than the threshold amount of metadata, the one or more back-office servers 24 may then divide the target region 32 into two or more subregions 60. The method 700 may then proceed to block 708.

In block 708, the one or more back-office servers 24 assign a specific timespan to each subregion 60 within the target region 32. The specific timespan corresponding to each subregion 60 indicates the dates and times of when the metadata for analyzing the nodes 62 and edges 64 included by each subregion 60 was collected. The method 700 may then proceed to block 710.

In block 710, the one or more back-office servers 24 construct an undirected graph 66 for each of the two or more subregions 60 of the target region 32, where each undirected graph 66 includes a plurality of nodes 62 that each represent a vehicle 30 of the plurality of vehicles 30 of the vehicle population 28 and a plurality of edges 64 that each represent a wireless connection between two of the vehicles 30. The method 700 may then proceed to block 712.

In block 712, the one or more back-office servers 24 calculate a modified cumulative rank score for each node 62 (i.e., each vehicle 30) included within the target region 32. The method 700 may then proceed to block 714.

In block 714, the one or more back-office servers 24 identify one or more vehicles 30 from each subregion 60 that is part of the target region 32 as one of the data mules 20 based on the modified cumulative rank score corresponding to each of the plurality of vehicles 30 that are part of the vehicle population 28. The method 700 may then proceed to block 716.

In block 716, the one or more back-office servers 24 transmit the most recent version of the latency-tolerant data to the data mules 20. The method 700 may then proceed to block 718.

In block 718, the data mules 20 may transmit the latency-tolerant data to the vehicle population 28 while traveling along a navigational route. It is to be appreciated that in embodiments, the navigational route followed by a particular vehicle 30 may be altered so that the particular vehicle 30 encounters a data mule 20 to receive the latency-tolerant data. The method 700 may then terminate.

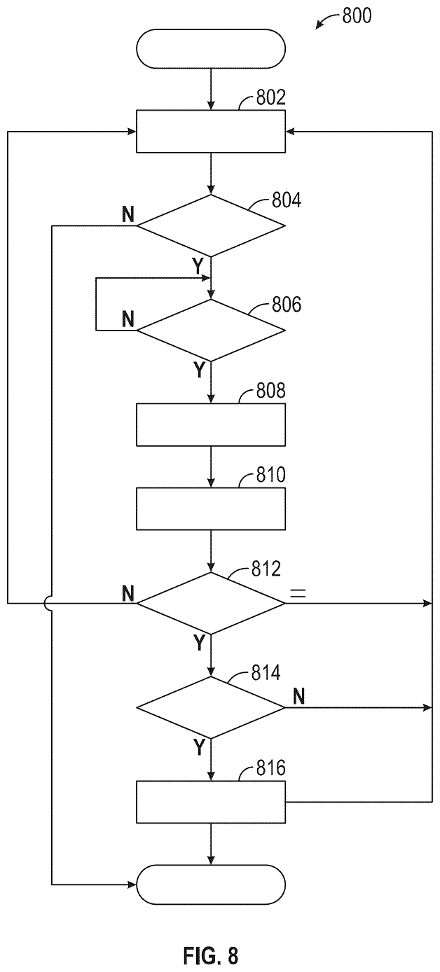

Referring back to FIG. 1, the spontaneous spreading approach shall now be described. During the spontaneous spreading approach, the data mule 20 is driving along a navigational route selected by the user associated with the data mule 20. It is also to be appreciated that network sharing such as V2V communication is enabled before the data mule 20 may transmit the latency-tolerant data with the vehicle population 28. FIG. 8 is a process flow diagram illustrating a method 800 of transmitting the latency-tolerant data from the data mule 20 to one of the vehicles 30 that are part of the vehicle population 28 based on the spontaneous spreading approach. The method 800 may begin at block 802. In block 802, the one or more controllers 22 of the data mule 20 monitor the amount of battery charge remaining for the data mule 20. The method 800 may then proceed to decision block 804.

In decision block 804, the one or more controllers 22 of the data mule 20 compare the amount of battery charge remaining with a threshold battery charge. The threshold battery charge indicates the vehicle battery has sufficient charge for the data mule 20 to transmit the latency-tolerant data received from the one or more back-office servers 24 to a vehicle 30. In response to determining the amount of battery charge is less than the threshold battery charge, the method 800 may terminate. Otherwise, the method 800 may proceed to decision block 806.

In decision block 806, the one or more controllers 22 of the data mule 20 monitor the surrounding area for the presence of one of the vehicles 30 that are part of the vehicle population 28. Specifically, the surrounding area is based on the transmission range of the short-range wireless communication protocol that wirelessly connects the plurality of vehicles 30 that are part of the vehicle population 28 to one another, such as the V2V communication network. The one or more controllers 22 of the data mule 20 continue to monitor the surrounding area until detecting the presence of one of the vehicles 30. The method 800 may then proceed to block 808.

In block 808, the one or more controllers 22 of the data mule 20 may then establish a wireless connection to the vehicle 30 detected within the surrounding area. The method 800 may then proceed to block 810.

In block 810, the one or more controllers 22 of the data mule 20 may then compare a last-modified timestamp of the latency-tolerant data received from the one or more back-office servers 24 with the last-modified timestamp of the data files of the vehicle 30 in wireless communication with the data mule 20 to determine which vehicle has the most recent version of data. The method 800 may then proceed to decision block 812.

In decision block 812, in response to determining the last-modified timestamp of the latency-tolerant data received from the one or more back-office servers 24 is the same as the last-modified timestamp of the data files of the vehicle 30, the one or more controllers 22 of the data mule 20 determine no update is required, and the method 800 may return to block 802. In response to determining the latency-tolerant data received from the one or more back-office servers 24 is older when compared to the last-modified timestamp of the data files of the vehicle 30 in wireless communication with the data mule 20, the one or more controllers 22 of the data mule 20 may receive updated latency-tolerant data from the vehicle 30. The method 800 may then return to block 802. In response to determining the latency-tolerant data received from the one or more back-office servers 24 is newer than the last-modified timestamp of the data files of the vehicle 30, the method 800 may then proceed to decision block 814.

In decision block 814, the one or more controllers 22 may then perform a diagnostic to confirm the health of the data mule 20. Specifically, the diagnostic may check for error codes such as, for example, diagnostic trouble codes (DTCs) that indicate an issue with one or more vehicle systems. In response to determining one or more error codes are present, the method 800 may then return to block 802. Otherwise, the method 800 may then proceed to block 816.

In block 816, the one or more controllers 22 of the data mule 20 may then transmit the latency-tolerant data received from the one or more back-office servers 24 to the vehicle 30, and the vehicle 30 may then perform either a full or partial update of its data files. The method 800 may then terminate or return to block 802.

Referring back to FIG. 1, in order to maintain a secure connection while transmitting the latency-tolerant data, all of the vehicles 30 that are part of the vehicle population 28 have the ability to authenticate messages received from the one or more back-office servers 24. Furthermore, the back-office servers 24 will authenticate all of the vehicles 30 of the vehicle population 28 as well. It is also to be appreciated that all the vehicles 30 that are part of the vehicle population 28 (including the data mules 20) are able to pool latency-tolerant data files from the back-office servers 24 securely.

In order to transmit the latency-tolerant data from a data mule 20 to a vehicle 30, it is to be appreciated that the one or more controllers 22 of the data mule 20 may generate a digital signature that may be authenticated by the vehicle 30. Alternatively, the one or more controllers 22 of the data mule 20 may download a batch of digital signatures from the one or more back-office servers 24. In another implementation, the one or more controllers 22 of the data mule 20 may have a batch of digital signatures built in during the manufacturing build process. The digital signature is stored within a hardware security module and includes an expiration date and time. The data mule 20 attaches a valid digital signature to the latency-tolerant data files that are transmitted to a vehicle 30, where the vehicle 30 may authenticate the latency-tolerant data files by verifying the digital signature. The latency-tolerant data files are discarded if the digital signature is not valid or has expired and are accepted if the digital signature is valid and has not expired.

Referring generally to the figures, the disclosed data propagation system provides various technical effects and benefits. Specifically, the data propagation system spreads latency-tolerant data to a vehicle population and other devices while minimizing the number of active polling connections to the back-office server. Minimizing the number of polling connections to the back-office servers results in fewer resources that are required to distribute the latency-tolerant data. Minimizing the number of polling connections may also address the issues faced with vehicles that are located in remote or rural areas with limited network connectivity and may not always be able to connect with the back-office servers. Furthermore, since the data mules maintain the polling connection to the back-office servers, the remaining vehicles that have not been selected as data mules may benefit from not having to maintain a polling connection to the back-office server, which may drain the vehicle's battery.

The modules may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the modules may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A data propagation system including one or more data mules transmitting latency-tolerant data across a vehicle population that includes a plurality of vehicles, the data propagation system comprising:
one or more controllers that are part of an ego vehicle, wherein the ego vehicle is part of the vehicle population, and wherein the one or more controllers include one or more processors that execute instructions to:
establish a wireless connection to a geofence network as the ego vehicle drives along a navigational route, wherein the geofence network represents a virtual polygon that bounds a specific geographical area and includes one or more stationary communication nodes and one or more moveable communication nodes that define the virtual polygon, and wherein the one or more data mules are part of the geofence network and are located within the virtual polygon that bounds the specific geographical area of the geofence network;
in response to connecting with the geofence network, select a particular data mule located within the specific geographical area of the geofence network to receive the data, wherein the particular data mule maintains a polling connection to receive the latency-tolerant data from one or more back-office servers;
monitor the wireless connection between the ego vehicle and the geofence network to determine the ego vehicle has driven outside of the specific geographical area bounded by the geofence network; and
in response to determining the ego vehicle has driven outside of the specific geographical area bounded by the geofence network, disconnect the wireless connection to the geofence network.

2. The data propagation system of claim 1, wherein the size of the virtual polygon that bounds the specific geographical area of the geofence network is dynamically expanded by introducing one or more additional communication nodes to the geofence network.

3. The data propagation system of claim 2, wherein the virtual polygon of the geofence network is dynamically expanded based on a pointer network-based convex hull.

4. The data propagation system of claim 1, wherein the one or more stationary communication nodes are represented by one or more of the following: buildings, infrastructure, vehicle dealerships, original equipment manufacturer (OEM) infrastructure, and infrastructure that the OEM has an agreement with.

5. The data propagation system of claim 1, wherein the one or more moveable communication nodes are represented by one or more of the following: one of the plurality of vehicles that are part of the vehicle population, the ego vehicle, and the one or more data mules.

6. The data propagation system of claim 1, wherein the ego vehicle is a software-defined vehicle.

7. The data propagation system of claim 1, wherein the latency-tolerant data includes at least one of the following: software configuration data, weather data, vehicle configuration data, news, local events, traffic updates, map data updates, software application updates, and vehicle software updates.

8. The data propagation system of claim 1, wherein two or more data mules are located within the geofence network, and wherein the one or more controllers of the ego vehicle execute instructions to select the particular data mule based on one or more selection criteria.

9. The data propagation system of claim 8, wherein the one or more selection criteria include one or more of the following: a distance between the particular data mule to the ego vehicle, a freshness of the latency-tolerant data received by the particular data mule from the one or more back-office servers, and one or more user-based preferences.

10. The data propagation system of claim 1, wherein the one or more controllers wirelessly connect to the one or more data mules by a heterogenous mesh network.

11. A method for identifying one or more vehicles that are part of a vehicle population as a data mule that transmits latency-tolerant data across a vehicle population, the method comprising:
dividing, by one or more back-office servers, a target region into two or more subregions, wherein a plurality of vehicles that are part of the target region are located within the target region and the one or more back-office servers are in wireless communication with the plurality of vehicles;
constructing, by the one or more back-office servers, an undirected graph for each of the two or more subregions of the target region, wherein each undirected graph includes a plurality of nodes that each represent one of the plurality of vehicles of the vehicle population and a plurality of edges that each represent a wireless connection between two of the plurality of vehicles;
calculating a modified cumulative rank score for each node included within the target region;
identifying one or more vehicles from each of the two or more subregions that are part of the target region as the data mule based on the modified cumulative rank score corresponding to each of the plurality of vehicles that are part of the vehicle population;
transmitting, by the one or more back-office servers, a most recent version of the latency-tolerant data to the one or more data mules, wherein the one or more data mules maintain a polling connection to receive the latency-tolerant data from one or more back-office servers; and
transmitting, by the one or more the data mules, the latency-tolerant data to the plurality of vehicle that are part of the vehicle population.

12. A data propagation system that includes one or more data mules transmitting latency-tolerant data across a vehicle population including a plurality of vehicles located within a target region, the data propagation system comprising:
one or more back-office servers in wireless communication with the plurality of vehicles that are part of the vehicle population, wherein the one or more back-office servers include one or more processors that execute instructions to:
divide a target region into two or more subregions, wherein a plurality of vehicles that are part of the target region are located within the target region and the one or more back-office servers are in wireless communication with the plurality of vehicles;
construct an undirected graph for each of the two or more subregions of the target region, wherein each undirected graph includes a plurality of nodes that each represent one of the plurality of vehicles of the vehicle population and a plurality of edges that each represent a wireless connection between two of the plurality of vehicles;
calculate a modified cumulative rank score for each node included within the target region;
identify one or more vehicles from each of the two or more subregions that are part of the target region as the data mule based on the modified cumulative rank score corresponding to each of the plurality of vehicles that are part of the vehicle population; and
transmit a most recent version of the latency-tolerant data to the data mules, wherein the data mules maintain a polling connection to receive the latency-tolerant data from one or more back-office servers and transmit the latency-tolerant data to the plurality of vehicles that are part of the vehicle population.

13. The data propagation system of claim 12, wherein the modified cumulative rank score is determined based on a local performance score and a global performance score.

14. The data propagation system of claim 13, wherein the local performance score is represented by an improved network connectivity coefficient that is a measure of first-degree connections and second-degree connections of a particular vehicle over a specific timespan assigned to a subregion the particular vehicle is located within.

15. The data propagation system of claim 14, wherein where the specific timespan is determined based on the frequency of interactions between the plurality of vehicles located within a particular subregion.

16. The data propagation system of claim 13, wherein the global performance score is represented by a tenacity of a particular vehicle, and wherein the tenacity is a measure of the importance of a particular vehicle in maintaining the wireless connections between the plurality of vehicles of the vehicle population.

17. The data propagation system of claim 13, wherein the local performance score is determined as:
$$modified cumulative rank score = ( local performance score * α ) + ( global performance score * β )$$
wherein α represents a local performance weight and β represents a global performance weight.

18. The data propagation system of claim 12, wherein the plurality of vehicles include at least one software-defined vehicle.

19. The data propagation system of claim 12, wherein the latency-tolerant data includes at least one of the following: software configuration data, weather data, vehicle configuration data, news, local events, traffic updates, map data updates, software application updates, and vehicle software updates.

20. The data propagation system of claim 12, wherein one or more controllers of each data mule execute a startup subscribe logic that identifies a particular vehicle that is part of the vehicle population as a potential data mule.
